(19) United States
(12) Patent Application Publication
(10) Pub. No.: US 2011/0232370 A1
(43) Pub. Date: Sep. 29, 2011

(54) TEST PORT ADAPTER FOR EP OVERLAY

(75) Inventors: Jeffrey F. SAUTER, Lowville, NY (US); Dan ROWLAND, Adams Center, NY (US)

(73) Assignee: NEW YORK AIR BRAKE CORPORATION, Watertown, NY (US)

(21) Appl. No.: 13/074,753

(22) Filed: Mar. 29, 2011

Related U.S. Application Data
(60) Provisional application No. 61/318,469, filed on Mar. 29, 2010.

(51) Int. Cl. B60T 17/22

(52) U.S. Cl. 73/39

(57) ABSTRACT

A test port adapter plate is used with an electropneumatic overlay access plate, which is incorporated to the single-sided pipe bracket in an overlay system, to provide enough space for a test connector to be connected.

### BACKGROUND AND SUMMARY OF THE DISCLOSURE

A single-sided pipe bracket for a pneumatic brake control valve for a rail vehicle has a service portion and emergency portion mounted on the side of the pipe bracket. Test ports are provided on the same face to provide access to a test of the brake valve. An example of the single-sided pipe bracket with test ports and a test connector for accessing the test ports is shown in U.S. Pat. No. 5,559,281, which is incorporated herein by reference.

There are presently two types of electropneumatic (EP) brake control valves for rail vehicles, namely overlay and stand alone. Both are described in U.S. Pat. No. 5,967,620, which is incorporated herein by reference. In the overlay system an access plate provided access to the interface of one of the service and emergency portions with the pipe bracket as shown in FIGS. 1 and 2A of U.S. Pat. No. 5,967,620.

With the incorporation of the overlay access plate to the single-sided pipe bracket in an overlay system, there is not enough space for the test connector to be connected. The present disclosure is directed to a test port adapter plate to be used with the EP overlay, single-sided pipe bracket allowing use of the test connector described in U.S. Pat. No. 5,559,281.

These and other objects, features, and advantages of the present disclosure may be better understood and appreciated from the following detailed description of the embodiments thereof, selected for purposes of illustration and shown in the accompanying drawings.

### BRIEF DESCRIPTION OF THE DRAWINGS

FIG. 1 is a front view of a single-sided pipe bracket with test ports;

FIG. 2 is a front view of an EP overlay, single-sided pipe bracket brake control valve with an adapter according to the present disclosure;

FIG. 3 is a plan view of the brake control valve of FIG. 2; and

FIG. 4 is a cross-sectional view of the adapter according to the present disclosure.

### DETAILED DESCRIPTION OF THE PREFERRED EMBODIMENTS

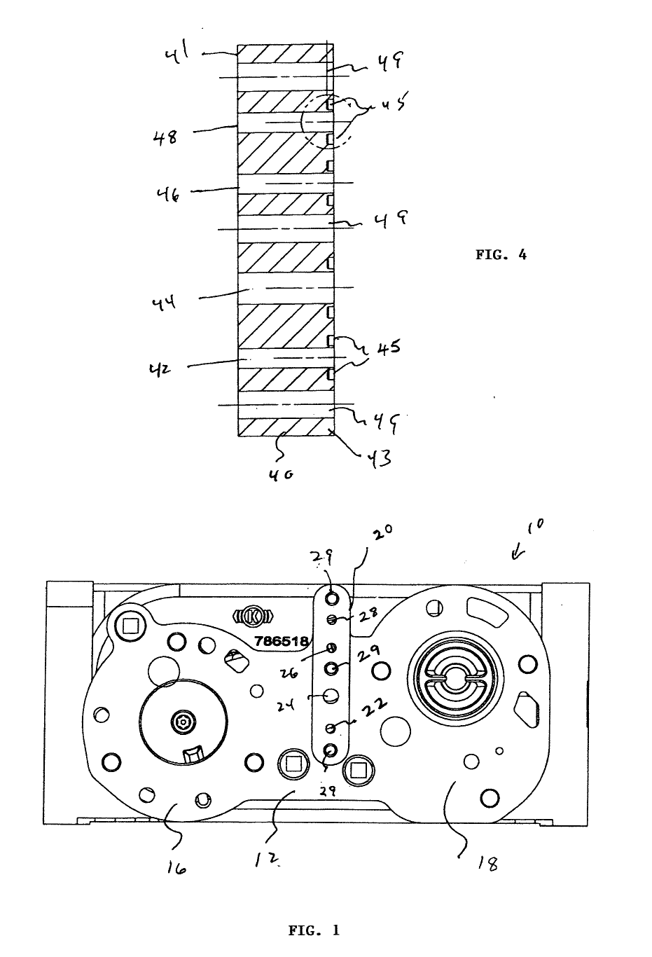

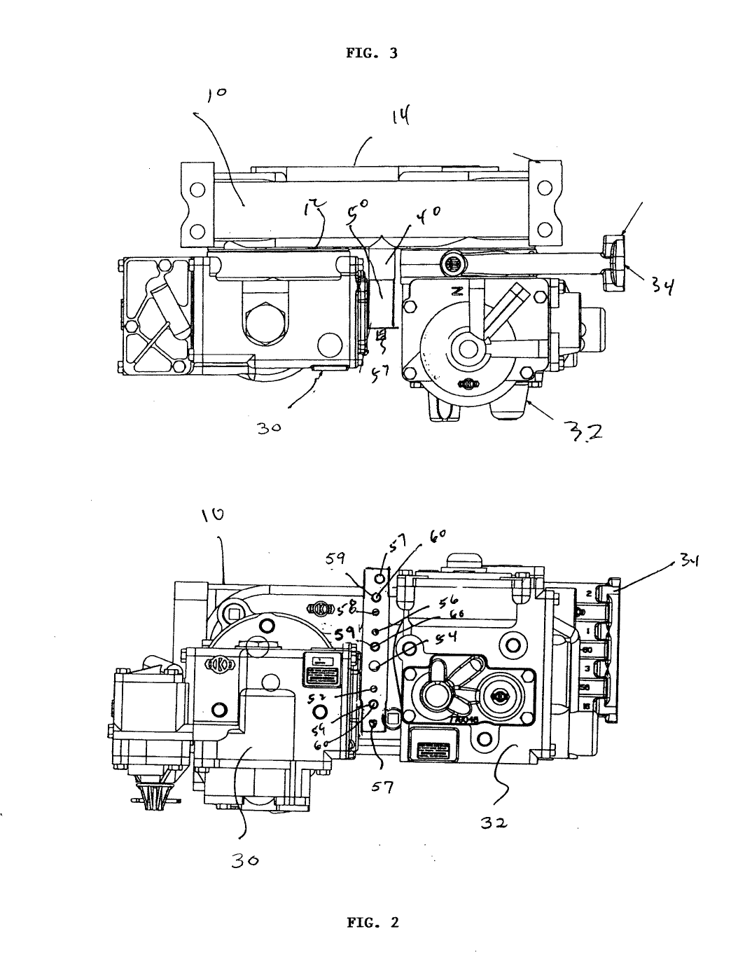

A pipe bracket 10, as shown in FIGS. 1 and 3, includes a front face or surface 12 and a back face or surface 14. The front surface 12 includes mounting surface 16 for the service portion 30 and mounting surface 18 for the emergency portion 32. An EP access plate 34 for an EP car control device CCD is connected between the emergency mounting surface 18 and the emergency portion 32.

The face 12 of the pipe bracket 10 includes four test ports 22, 24, 26 and 28. Also, three threaded bores 29 are provided to receive fasteners for mounting the adapter 40 of the present disclosure and the access housing 50 of the test connector of U.S. Pat. No. 5,559,281. For detailed explanation of the complete test connector and details of the access housing 50, see U.S. Pat. No. 5,559,281.

The adapter 40, as shown in detail in FIG. 4, includes test port passages 42, 44, 46 and 48 to align with test ports 22, 24, 26 and 28 respectively. Through bores 49 align with the threaded holes 29 respectively. Recesses 47 in the front face 43 of the adapter 40 around the test ports passages 42, 44, 46 and 48 receive gaskets, not shown. The rear face 41 of the adapter 40 engages the front face 12 of the pipe bracket 10.

The access housing 50 of the test connector, as shown in FIG. 2, includes test port passages 52, 54, 56 and 58 to align with test port passages 42, 44, 46 and 48 respectively. Through bores 59 align with the through bores 49 respectively of the adapter 40. Fasteners 60 extent through the through bore 59 and 49 and are screwed into threaded bores 29 in the pipe bracket. Threaded studs 57 extend from the access housing 50 to receive and secure a test connector.

The depth of the adapter 40 is the same as the depth of the EP access plate 34. Thus the added depth for the emergency portion 32 is compensated and the access housing and the test connector are accessible.

Although the test connector of U.S. Pat. No. 5,559,281 is used as an example, other test connectors and access housings may be used.

Accordingly, it will be understood that the preferred embodiment of the present invention has been disclosed by way of example and that other modifications and alterations may occur to those skilled in the art.

What is claimed:

1. An adapter for connecting a test connector to a plurality of test ports of an electropneumatic overlay, single sided pipe bracket.

2. The adapter according to claim 1, wherein said plurality of test ports are in fluid pressure communication with a respective one of a brake pipe, an auxiliary reservoir, an emergency reservoir and a brake cylinder device of a railroad car.

3. The adapter according to claim 1, wherein said test connector is connected to a control valve device at said plurality of test ports thereof for conducting fluid under pressure from said test ports to apparatus for testing operation of the railroad car brakes.

4. The adapter according to claim 1, wherein said plurality of test ports are normally closed by check valve means.

5. The adapter according to claim 1, wherein said test connector comprises:
a body having a plurality of channels therethrough aligned with corresponding ones of said test ports;
actuator means reciprocally disposed in respective ones of said plurality of channels for opening said check valve means each said actuator means comprising:
a stem having one end adjacent said check valve means;
a piston member operatively connected to said stem and cooperatively arranged with said channel therefor to form a pilot chamber on one side of said piston member; and
bias means acting on the other side of each said piston member for urging movement of each said actuator means in a first direction away from engagement of said one end of said stems with said check valve means; and
means for connecting a supply of fluid under pressure to each said pilot chamber to urge each said actuator means in a direction opposite said first direction to effect engagement of said one end of said stems with said check valve means to effect opening thereof, whereby the fluid under pressure effective at said test ports is conducted to said test apparatus via said channels.

6. The adapter according to claim 5, wherein said body comprises:
an adapter plate having first and second faces and a plurality of through bores, said first face adjoining said control valve device;
a connector plate affixed to said adapter plate and having a through bore aligned with each said through bore in said adapter plate, said connector plate having a first face adjoining said second face of said adapter plate; and
a plurality of hose fittings in said second face of said connector plate each communicated with a respective one of said bores therein, said bores in said adapter plate and said bores in said connector plate forming said channels of said test connector.
